(19) United States
(12) Patent Application Publication
(10) Pub. No.: US 2025/0176703 A1
(43) Pub. Date: Jun. 5, 2025

(54) ELECTRIC TOOTHBRUSH WITH OPTIMIZED MECHANICAL DESIGN

(71) Applicant: CONCEPTEETH, Valbonne (FR)

(72) Inventor: Thierry André Christian VALLET, LA FOUILLOUSE (FR)

(21) Appl. No.: 18/837,798

(22) PCT Filed: Mar. 15, 2023
(86) PCT No.: PCT/FR2023/050353

§ 371 Date: Aug. 12, 2024

(30) Foreign Application Priority Data
Mar. 18, 2022 (FR) FR2202396

(51) Int. Cl. A46B 13/00; A46B 9/04; A46B 13/02; A61C 17/22; A61C 17/26

(52) U.S. Cl. CPC A46B 13/006; A46B 9/04; A46B 13/02; A61C 17/222; A61C 17/26; A46B 2200/1066

(57) ABSTRACT

The invention concerns a toothbrush comprising a brushing roller (4), a drive shaft with a first end secured to said brushing roller (4), said toothbrush comprising a first casing (30) within which runs said drive shaft, as well as a cover (8), made of a first material, having an internal face facing said roller (4), said drive shaft comprising an extremal segment emerging from said first casing (30) and including said first end, said brush comprising a bearing receiving said extremal segment, said toothbrush comprising a protective piece (9) made of a second material softer than said first material, said protective piece (9) cladding said internal face and projecting from the latter to form a lip (90), said protective piece (9) forming said bearing.

Oral hygiene instruments.

### TECHNICAL FIELD

The present invention relates to the general technical field of oral hygiene instruments, and more particularly to the field of toothbrushes, especially for human use.

The present invention concerns more particularly an electric toothbrush comprising an electric motor, a roller for brushing teeth, a drive shaft running longitudinally between a first end secured to said brushing roller and a second end connected to said electric motor for rotating said brushing roller through said drive shaft along a first rotation axis, said brushing roller running longitudinally between a proximal end attached to said drive shaft and a free distal end, said toothbrush further comprising a first casing within which runs said drive shaft, as well as a cover, made of a first material, which extends longitudinally said first casing and runs along said brushing roller between a rear end secured to the first casing and a free front end, said cover having an internal face located facing said brushing roller and an opposite external face, said drive shaft comprising an extremal segment emerging outside said first casing and which includes said first end, said toothbrush comprising a bearing which is secured to said first casing and receives said extremal segment to guide it.

### PRIOR TECHNIQUE

It is known electric toothbrushes implementing a motorized brushing member. These electric toothbrushes generally give satisfaction, because they allow an effective brushing, under conditions particularly comfortable for the user since the implementation of a motorization makes it possible to reduce the gestures to be performed.

These known electric toothbrushes nevertheless have serious drawbacks.

In particular, the known electric toothbrushes generally have a design which primarily prioritizes the brushing efficiency, sometimes to the detriment of comfort and protection of tissues (including the gums). The known electric toothbrushes are therefore likely to cause at least some discomfort, even bruising and pain.

These known electric toothbrushes also do not allow to provide an optimal brushing and their mechanical design is a source of durability and reliability problems.

### DISCLOSURE OF THE INVENTION

The objects assigned to the invention therefore aim to remedy the drawbacks disclosed in the above and to propose a new electric toothbrush which, while being of compact and economical construction, provides remarkable comfort and safety of use, while allowing to perform particularly effective and atraumatic brushing.

Another object of the invention aims to propose a new electric toothbrush whose design allows a precise brushing and an optimal comfort.

Another object of the invention aims to propose a new electric toothbrush whose design allows rapid, simple and economical manufacturing.

Another object of the invention aims to propose a new particularly robust and lightweight electric toothbrush.

Another object of the invention aims to propose a new electric toothbrush of particularly durable construction.

Another object of the invention aims to propose a new electric toothbrush whose design allows an optimized industrial manufacturing.

Another object of the invention aims to propose a new electric toothbrush whose design makes it possible to limit parasitic vibrations and to improve the lifespan of the components which form the toothbrush.

The objects assigned to the invention are achieved by using an electric toothbrush comprising an electric motor, a roller for brushing teeth, a drive shaft running longitudinally between a first end secured to said brushing roller and a second end connected to said electric motor for rotating said brushing roller through said drive shaft along a first rotation axis, said brushing roller running longitudinally between a proximal end attached to said drive shaft and a free distal end, said toothbrush further comprising a first casing within which runs said drive shaft, as well as a cover, made of a first material, which extends longitudinally said first casing and runs along said brushing roller between a rear end secured to the first casing and a free front end, said cover having an internal face located facing said brushing roller and an opposite external face, said drive shaft comprising an extremal segment emerging outside said first casing and which includes said first end, said toothbrush comprising a bearing which is secured to said first casing and receives said extremal segment to guide it, said electric toothbrush being characterized in that it comprises a protective piece made of a second material softer than said first material, said protective piece cladding said internal face and projecting from the latter to form a peripheral lip surrounding said cover, said protective piece including a ring locally surrounding said extremal segment to form said bearing.

### BRIEF DESCRIPTION OF THE DRAWINGS

Other particularities and advantages of the invention will appear in more detail in reading the detailed description which follows, in reference to the accompanying drawings, given as purely illustrative and non-limiting examples, in which:

FIG. 1 illustrates, in a schematic front view in elevation, an electric toothbrush according to the invention.

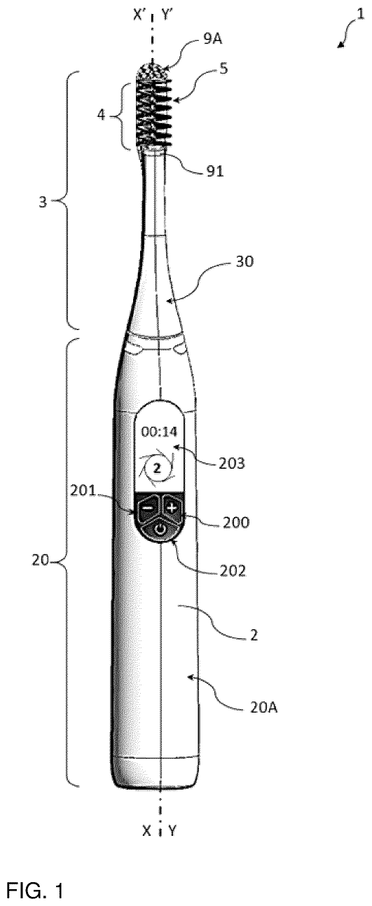

FIG. 2 illustrates, in a schematic perspective view, a detail of construction of the electric toothbrush of FIG. 1, which is part of a removable brushing head.

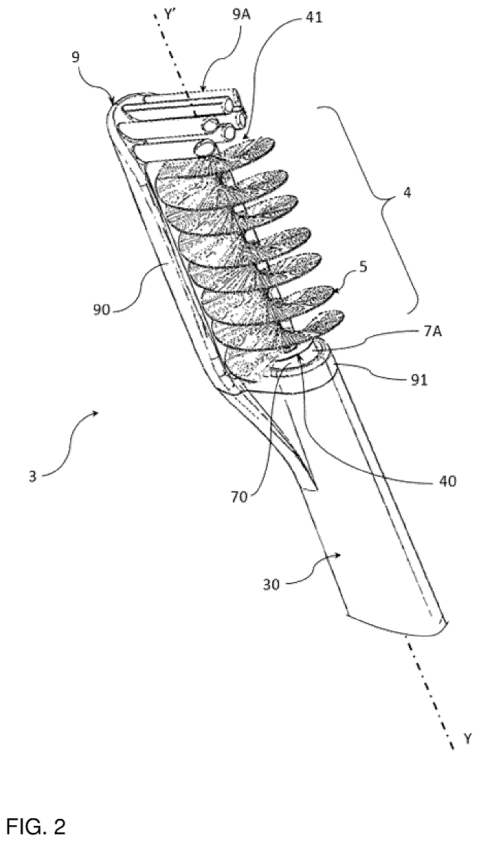

FIG. 3 is a schematic perspective figure which illustrates, in a three-quarter rear elevation view, a detail of construction of the electric toothbrush of the preceding figures.

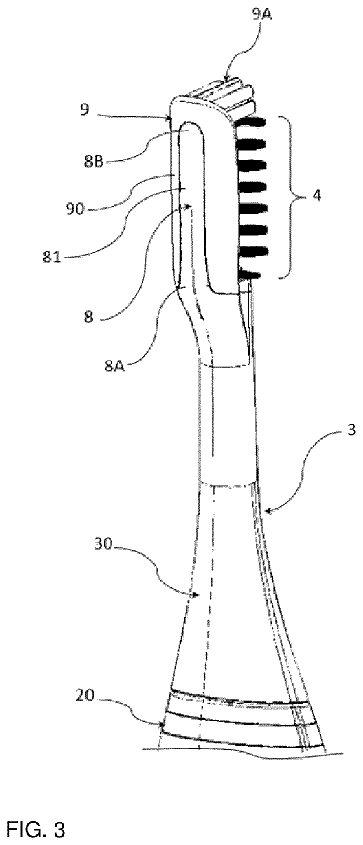

FIG. 4 is a schematic perspective figure which illustrates, in a three-quarter front elevation view, a detail of construction of the electric brush of the previous figures, where the brushing roller has been omitted.

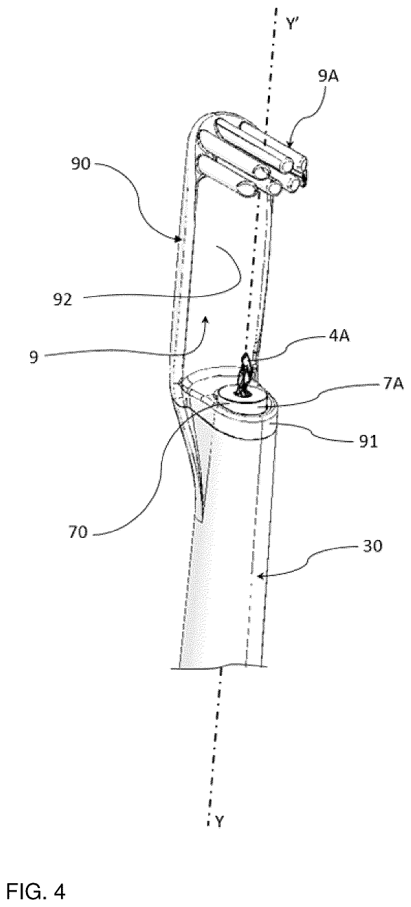

FIG. 5 illustrates, in a schematic perspective view, the protective piece of the toothbrush of the preceding figures, which protective piece is made in this case of soft plastic material and is intended to cover, in this case completely, the internal side of the cover of the toothbrush.

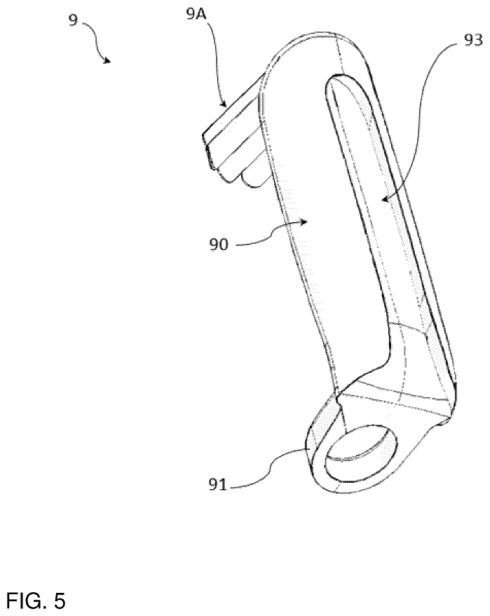

FIG. 6 illustrates the same detail of construction as that illustrated in FIG. 4, with the difference that the protective piece has also been omitted to allow the internal face of the cover to be viewed.

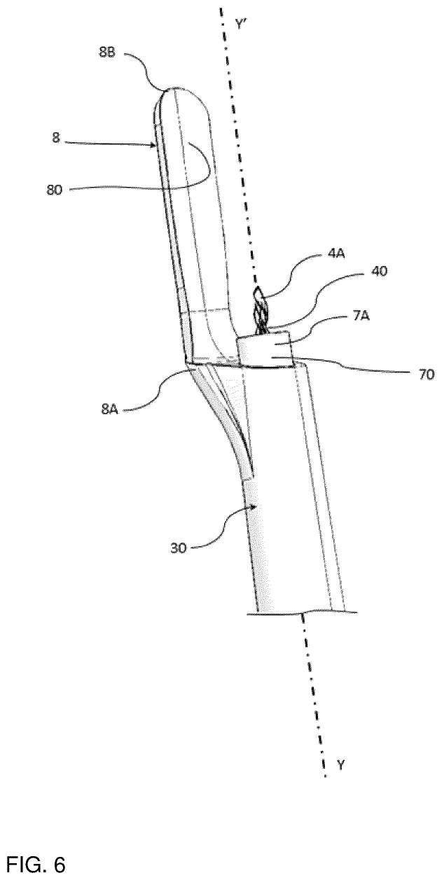

FIG. 7 illustrates, in a schematic view in longitudinal section, a detail of construction of the electric toothbrush of the previous figures, with the brushing roller represented schematically by a cylinder.

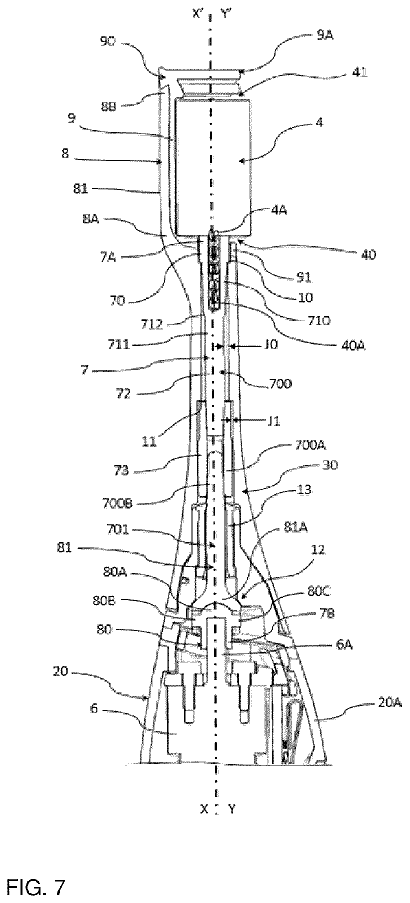

FIG. 8 illustrates, in a schematic perspective view, a detail of construction of the electric toothbrush of the preceding figures, which is part of a main body intended to be removably coupled with the brushing head which includes the detail of construction illustrated in FIG. 2.

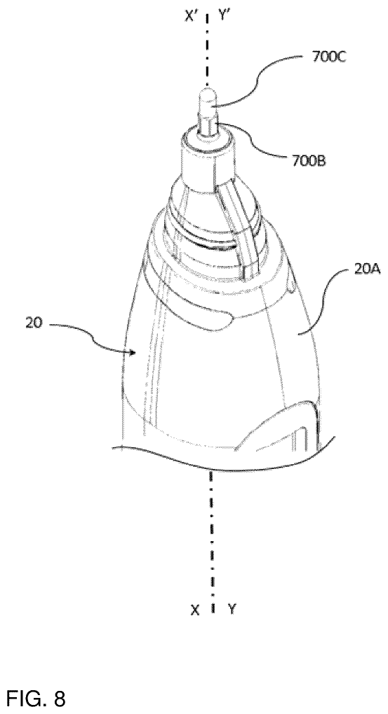

FIG. 9 illustrates, in a schematic perspective view, the brushing head which includes the detail of construction illustrated in FIG. 2 forms part, said brushing head being intended to be coupled to the main body, a detail of which is illustrated in FIG. 8, the brush roll being omitted.

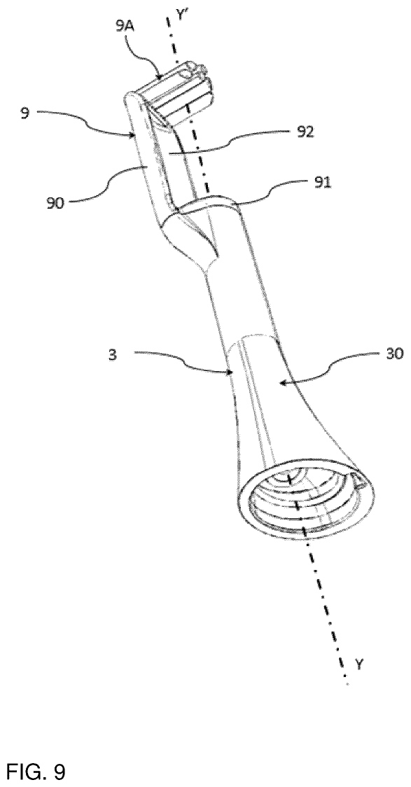

FIG. 10 illustrates, in a schematic view in longitudinal section, the brushing head of the toothbrush of the previous figures.

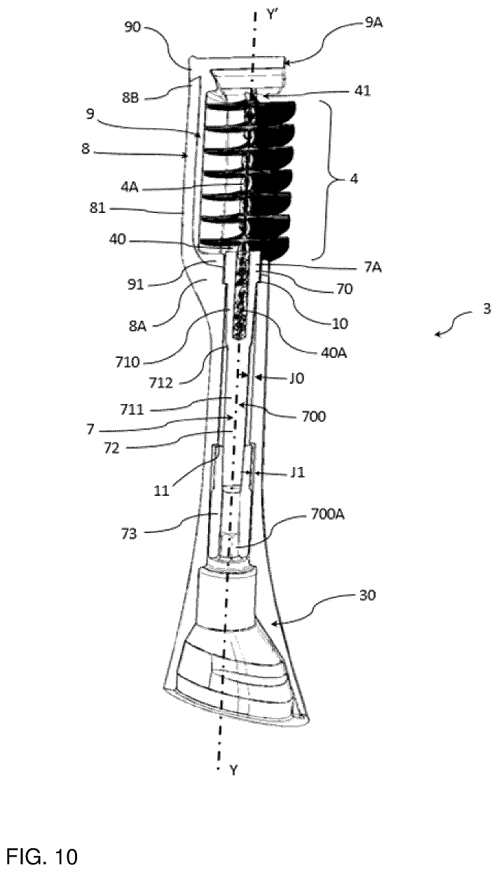

FIG. 11 illustrates, in a schematic view in longitudinal section, a detail of construction of the brushing head of FIG. 10, where a sub-assembly formed by the brushing roller and a receiving segment of the drive shaft is omitted.

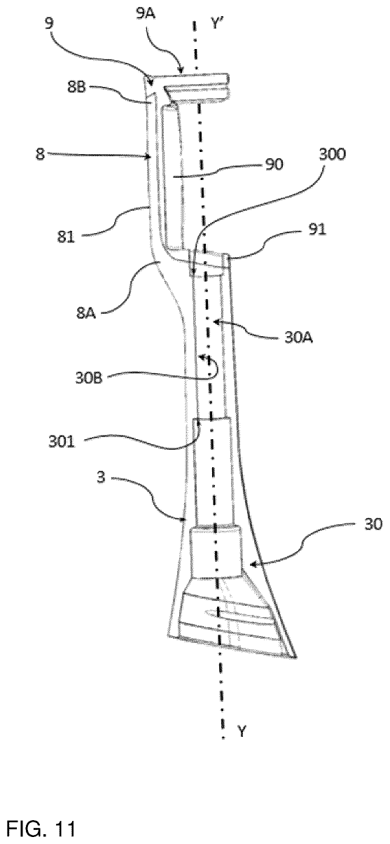

FIG. 12 illustrates, in a schematic view in longitudinal section, the sub-assembly formed by the brushing roller and the receiving segment of the drive shaft which is omitted in FIG. 11.

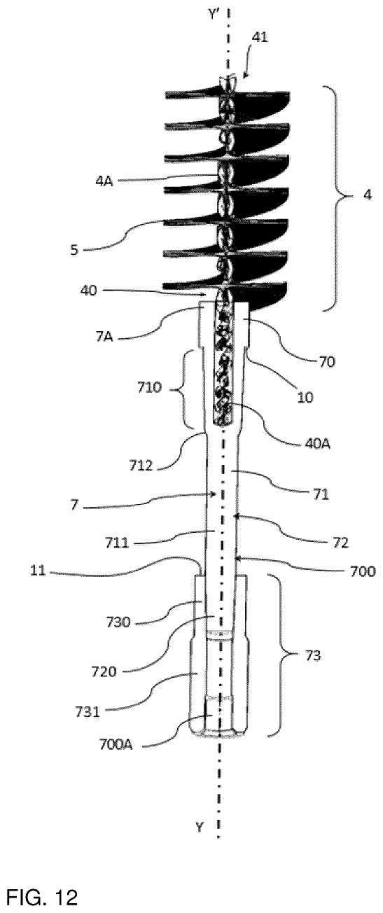

FIG. 13 illustrates, in a schematic perspective view, a detail of construction of the toothbrush of the previous figures, which corresponds to the kinematic chain of the latter, which includes the electric motor, the drive shaft (including a universal joint) and the brushing roller, the latter being represented in this case schematically by a cylinder.

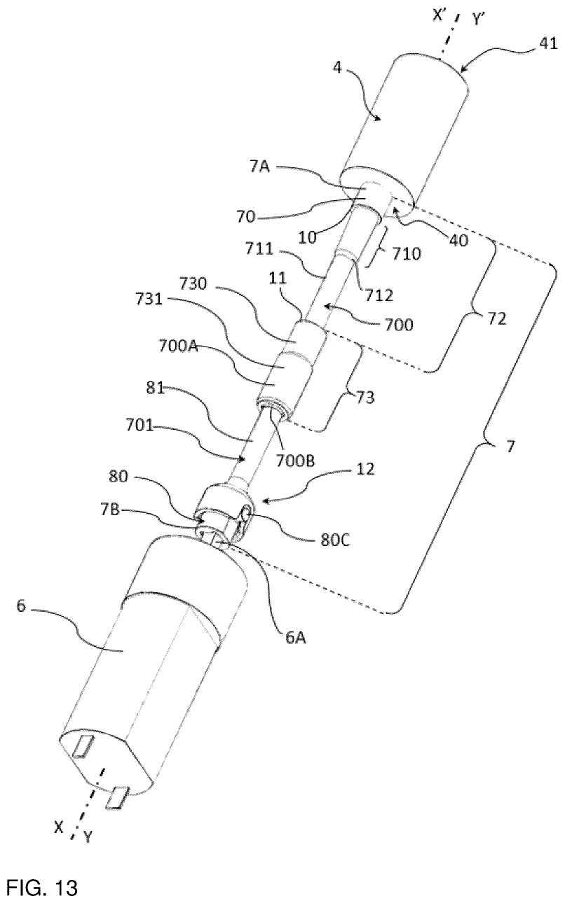

### BEST WAY TO IMPLEMENT THE INVENTION

It should be noted beforehand that the terms “first”, “second”, “primary”, “secondary”, etc. used in the present description do not necessarily have an ordinal or cardinal connotation, that is to say they do not imply here any notion of order, quantity or any categorization of the elements or components to which these terms are attached. In particular, the use of these terms does not necessarily imply the existence of associated items of higher order or rank. In this case, these terms are only intended to facilitate the understanding of the invention by making it possible to differentiate between them certain technical characteristics.

The invention concerns an electric toothbrush 1, intended to maintain oral hygiene by elimination of food debris and dental plaque. The electric toothbrush 1 according to the invention is advantageously intended for humans, but, according to an alternative embodiment, it can be perfectly adapted to a veterinary use, for example for farming or company animals.

Advantageously, the electric toothbrush 1 comprises a manual gripping member 2, which preferably forms a handle, intended to be grasped manually by a user, to allow the latter to manipulate the electric toothbrush 1 and in particular to control its position and its orientation in space, as well as its pressure in contact with the teeth to be brushed. The handle which advantageously forms the manual gripping member 2 runs for example longitudinally along a central longitudinal axis X-X′. Preferably, the toothbrush 1 comprises a main body 20, which advantageously comprises a second casing 20A within which are preferably intended to be housed different components, and in particular mechanical, electrical and electronic components of the electric toothbrush 1. Advantageously, the second casing 20A forms the manual gripping member 2.

Advantageously and as illustrated in the figures, the electric toothbrush 1 comprises a brushing head 3 which is preferably mounted on the main body 20, in the axial extension of the latter. Preferably, the brushing head 3 is removably mounted on the main body 20, in order to allow an easy replacement of the head 3, when for example one or more components of the latter are worn, or to alternatively use brushing heads with different characteristics. Thus, in the preferred embodiment illustrated in the figures, the electric toothbrush 1 comprises two distinct and independent mechanical sub-assemblies, corresponding respectively to the brushing head 3 and to the main body 20, said two sub-assemblies 3, 20 in question being designed to be able to be mechanically coupled in a removable, reversible manner, with a view to forming the electric toothbrush 1, which therefore advantageously has a modular character. It is however possible, in an alternative embodiment, for the brushing head 3 to be permanently fastened to the main body 20, without the possibility of separation.

The electric toothbrush 1 also comprises a member for brushing teeth, which is advantageously disposed substantially at one end of the electric toothbrush 1, which thus preferably has a generally slender shape which runs longitudinally along said central longitudinal axis X-X′. Preferably, the brushing member is part of the brushing head 3. More precisely, as illustrated in the figures, the brushing member is formed by a roller 4 for brushing teeth, which is designed to be brought into contact with the teeth in order to ensure the cleaning, in this case by an abrasive mechanical action of brushing. In order to ensure the brushing function assigned to it, the roller 4 for brushing teeth is advantageously provided with brushing protrusions 5, preferably formed by a plurality of bristles or pins. Said brushing protrusions 5 are preferably made of synthetic material, and advantageously have a substantially soft, flexible character. The roller 4 for brushing teeth is advantageously mounted to rotate along a first rotation axis Y-Y′, which is advantageously parallel to, and preferably coincident with, the central longitudinal axis X-X′ mentioned above. The brushing roller 4 is thus designed to rotate, preferably in a substantially continuous manner, in the same direction, which direction may advantageously be modified depending on the area of the dentition to be brushed and the positioning of the electric toothbrush 1 relative to this area. The use of a brushing roller 4 which rotates continuously in one direction of rotation or another is preferred, because it allows a particularly effective cleaning of the dentition while limiting the traumatic risk. The implementation of an oscillo-rotary or vibrant brushing member proves to be much less advantageous, in terms of compromise between the brushing efficiency and the minimization of the traumatic risk, than the use of a continuously rotary brushing roller 4, as provided by the invention.

The brushing roller 4 comprises for example, as illustrated in the figures, a central core 4A, formed in this case by a substantially elongated core, which is substantially coaxial with said first rotation axis Y-Y′. The brushing protrusions 5 preferably project radially from said central core 4A. Preferably, the brushing protrusions 5, advantageously formed by substantially soft pins or bristles, are distributed helically (as illustrated in the figures), along the first rotation axis Y-Y′. In other words, in this preferred embodiment, the brushing protrusions 5 each run between an internal end connected to the central core 4A and a free external end, such that they form a helix, or a spiral, around said central core 4A, along the latter. The brushing roller 4 thus advantageously forms a cylindrical brush in the shape of a swab.

For example, the central core 4A is formed by a metal wire folded into a U which is twisted on itself to capture, between the arms of said U, the brushing protrusions 5, so that the twisting in question imparts to the plurality of brushing protrusions 5 a helical distribution. Thanks to this helical expansion, in a spiral around the first rotation axis Y-Y′, the brushing roller 4 is particularly effective from the point of view of the cleaning action, while being capable of providing a gentle brushing which respects the sensitivity of the tissues concerned. The helical distribution of the brushing protrusions 5 also makes it possible to facilitate the deformation of the brushing surface formed by the brushing protrusions 5, thus authorizing a significant variation in the bulk volume of the brushing roller 4, thereby authorizing the latter to slip into areas of complex and narrow shapes, guaranteeing a brushing that is both effective and atraumatic.

In accordance with the invention, the electric toothbrush 1 comprises an electric motor 6, which is advantageously embedded by the main body 20, and is for example housed within the second casing 20A mentioned above which preferentially forms said manual gripping member 2. The electric motor 6 in question is preferably a direct current motor, with a stator, a rotor and an output shaft 6A secured to the rotor and rotated by the latter, either directly or indirectly (for example through a reduction device). Said electric motor 6 is intended to be powered by an electric supply current, which is preferably a direct current. Said electrical supply current passes through the motor to put said stator and rotor into relative rotation. Advantageously, in order to provide said electric supply current to the motor 6 as well as possibly to other electrical or electronic members on the brush 1, the latter comprises a source of energy embedded by the main body 20. Said source of energy is formed for example by at least one cell or battery, rechargeable or not, which is preferably housed within the gripping member 2, for example within said second casing 20A.

In accordance with the invention, the electric toothbrush 1 comprises a drive shaft 7 running longitudinally, preferably coaxially with the first rotation axis Y-Y′ (which itself advantageously coincides with the central longitudinal axis X-X′) between a first end 7A secured to said brushing roller 4 and a second end 7B connected to said electric motor 6 to drive in rotation, and preferably in continuous rotation as explained previously, said brushing roller 4 through said drive shaft 7 along the first rotation axis Y-Y′. To this end, the drive shaft 7 is preferably connected, towards its second end 7B, to an output shaft 6A of the electric motor 6. The output shaft 6A has for example a polygonal section (for example a square section) and is inserted in a footprint of conjugate shape disposed at the second end 7B, thus allowing a rotational drive along the first rotation axis Y-Y′ of the drive shaft 7 by the motor 6. The brushing roller 4 runs in turn longitudinally (that is to say in the direction materialized by the central longitudinal axis X-X′) between a proximal end 40 attached to said drive shaft 7, for example at the first end 7A of the latter, and a distal end 41. Said distal end 41 is free, that is to say that it is not extended or maintained, in particular by a mechanical guide member. The use of a free distal end 41 makes it possible to give the roller 4 for brushing teeth the ability to move, in particular by facilitating the flexion deformation of the central core 4A, which allows the roller 4 for brushing teeth to deflect, thus promoting brushing that is not only effective and precise, but also particularly gentle and atraumatic.

Preferably, the drive shaft 7 advantageously comprises a central well which opens at said first end 7A and within which is inserted a terminal portion 40A of the central core 4A which projects axially from the brushing roller 4. Preferably, the terminal portion 40A in question is press-fitted into said well provided at the first end 7A of the drive shaft 7, so as to allow a rotational drive, along the first axis Y-Y′, of the central core 4A by the drive shaft 7. Optionally, this securing by friction may be supplemented by additional fastening means (gluing for example). Thus, the central core 4A advantageously runs in continuity with the drive shaft 7, the latter being advantageously coaxial with the first rotation axis Y-Y′, which itself advantageously coincides with the central longitudinal axis X-X′, as illustrated in the figures.

As illustrated in the figures, the toothbrush 1 further comprises a first casing 30 within which runs, at least in part, said drive shaft 7. In the embodiment illustrated in the figures, a first part of the drive shaft 7 runs within the first casing 30 while a second part of said drive shaft 7 runs within the second casing 20A, said first and second parts of the drive shaft 7 which can be connected to each other in a removable manner, in order to allow the separation of the brushing head 3 and of the main body 20. It is however perfectly conceivable, without departing from the scope of the invention, that the brushing head 3 and the main body 20 are not detachable, so that the toothbrush 1 has in this case a one-piece character, with a single casing within which runs entirely the drive shaft 7. The first casing 30 is preferably made of a relatively rigid plastic material, for example a thermoplastic polymer. The thermoplastic polymer in question may for example be a styrenic polymer such as acrylonitrile butadiene styrene (ABS) or a polymer from the polyester family such as poly(butylene terephthalate) (PBT), or even a composite material formed by example of a thermoplastic polymer matrix loaded with glass fibers.

As illustrated in the figures, the toothbrush 1 further comprises a cover 8 which extends longitudinally the first casing 30 and runs along said brushing roller 4 between a rear end 8A secured to said first casing 30 and a free front end 8B. In other words, the cover 8 runs longitudinally substantially parallel to the central longitudinal axis X-X′, from an extremal portion of the first casing 30, so as to cover part of the fictitious cylindrical surface within which the brushing roller 4 fits. The cover 8 thus contributes to forming a screen which leaves only a portion of the lateral surface of the brushing roller 4 exposed. Preferably, the cover 8 is formed by a tongue, which is advantageously slightly curved to follow the profile of the brushing surface defined by the roller 4. The cover 8 thus has a tab shape which preferably runs over substantially the entire length of the roller 4. The cover 8 has more precisely an internal face 80 located facing said brushing roller 4, that is to say facing the latter, and an opposite external face 81. The cover 8 is advantageously made of a first material, which is for example a relatively rigid plastic material, for example a thermoplastic polymer. The thermoplastic polymer forming said first material may for example be a styrenic polymer such as acrylonitrile butadiene styrene (ABS) or a polymer from the polyester family such as poly(butylene terephthalate) (PBT). The cover 8, however, has a substantially flexible character, so that it can deform in flexion and possibly in torsion, to accompany for example a conjugated deformation of the roller 4, which again contributes to particularly effective, precise and atraumatic brushing.

Advantageously, the cover 8 is integral with the first casing 30. This means that in this preferred mode of relationship illustrated in the figures, the cover 8 and the first casing 30 are integrally formed by a single piece, obtained for example by molding a plastic material (such as for example a thermoplastic polymer such as ABS or PBT as mentioned above), the first casing 30 forming a hollow envelope delimiting an internal housing for the drive shaft 7, said hollow envelope being extended by a spatula-shaped flat piece corresponding to the cover 8.

As illustrated in the figures, the drive shaft 7 comprises an extremal segment 70 emerging outside the first casing 30 and which includes said first end 7A. In other words, the extremal segment 70 runs partly outside the first casing 30 and partly inside the latter, from which it projects so that said first end 7A is located outside the first casing 30. In order to ensure the guiding of the drive shaft 7, and the maintenance of the roller 4 for brushing teeth in an appropriate position, the toothbrush 1 comprises a bearing which is secured to the first casing 30 and receives said extremal segment 70 to guide it. The bearing thus makes it possible to locally maintain the extremal segment 70 in position relative to the first casing 30, while allowing the rotation of the drive shaft 7 along the first rotation axis Y-Y′.

According to the invention, the electric toothbrush comprises a protective piece 9 made of a second material which is softer than said first material. Said second material preferably has an elastic, deformable and soft character. The Shore A hardness of the second material is for example lower than that of the first material. Preferably, the value of the Shore A hardness of the second material is comprised between 40 and 80, and even more preferably between 50 and 70, particularly preferably is approximately equal to 60. The second material is for example an elastomer, or a thermoplastic elastomer (TPE), such as polystyrene-b-poly(ethylene-butylene)-b-polystyrene (SEBS) or polystyrene-b-polybutadiene-b-polystyrene (SBS). It is also possible to use, for example, a second silicone-like material.

The protective piece 9 is therefore advantageously less hard and more flexible than the cover 8. As illustrated in the figures, the protective piece 9 clads the internal face 80 of the cover 8 and projects beyond the latter to form a peripheral lip 90 surrounding said cover 8. In other words, the peripheral lip 90 covers the internal face 80 and projects laterally from the cover 8, thus forming with the latter an atraumatic protective guard.

Said protective guard aims to prevent the tissues of the oral cavity which are not subjected to the action of brushing by the roller 4 from unexpectedly coming into contact with the brushing roller 4, which could cause a discomfort or even trauma. In other words, the sub-assembly formed by the cover 8 and the protective piece 9 plays the role of a spacer partially covering the lateral surface of the brushing roller 4, so as to protect from the action of said roller 4 the mucous membranes neighboring the teeth, and more particularly the cheek, lips and even the tongue. Thus, the cover 8 and the protective piece 9 contribute to forming a sort of shield which masks a non-functional area of the brushing roller 4, in order to preserve the labial, jugal and lingual mucous membranes from the abrasive action of the roller 4. The shield in question thus makes it possible to separate the mucous membranes of the teeth to be brushed and thus to provide a sufficient space to place the roller 4 in the right position and allow the rotary movement of the latter along the vestibular, palatine and lingual surfaces of the teeth, as well higher than lower. This technical measure makes it possible, in other words, to obtain, by combining the cover 8 and the protective piece 9, a spacer which effectively ensures the protection of the mucous membranes while being extremely soft, deformable and atraumatic.

In addition, the protective piece 9 includes a ring 91 locally surrounding said extremal segment 70 to form said bearing.

The very specific design disclosed in the above has significant advantages. This design makes it possible to benefit from a bi-material protective guard capable of both providing a great comfort of use, with a minimization of the traumatic risk, and a controlled flexibility thanks to the presence of the cover 8 which is more rigid than the protective piece 9. In addition, the use of a ring 91 made of the second material to form the guide bearing of the drive shaft 7 at the outlet of the first casing 30 allows a variation in the angular orientation of said drive shaft 7. The inclination of the roller 4 for brushing teeth relative to the central longitudinal axis X-X′ is therefore facilitated, which is a source of brushing efficiency comfort and precision. The roller 4 for brushing teeth and the protective guard formed by the combination of the protective piece 9 and the cover 8 are thus advantageously capable of deflecting in a substantially concomitant manner, possibly according to different deformation profiles, allowing the end of the brushing head 3 to have an evolving shape capable of dynamically adapting to the mechanical stresses affecting the brushing head 3 during use. This deformability is optimized thanks to the implementation, in combination with the characteristics mentioned above, of a brushing roller 4 whose distal end 41 is free, that is to say not guided.

In particular, the conjugated flexibilities of the cover 8 and the protective piece 9 allow a significant flexibility of the head 3 with respect to the handle 2 and the central longitudinal axis X-X′ associated with the latter, according to for example a deflection angle (measured between the first axis Y-Y′ and the central longitudinal axis X-X′) which may reach approximately 7°.

The specific design disclosed in the above thus makes it possible to respect the proprioception of the dental organs and the heightened sensitivity of the gingival tissue to cuts.

Furthermore, the joint presence of the peripheral lip 90 and a ventral area 92, which is formed by the protective piece 9 and which preferably covers the internal face 80 substantially completely, makes it possible to preserve the tissues during deflection of the brushing roller 4. Thanks to the covering, preferably completely, of the internal face 80 by a layer of the second material forming said ventral area 92 of the protective piece 9, the brushing protrusions 5 which could be brought in use to come into contact with the internal face 80 come to rub against the ventral area 92, which, due to its soft, and preferably smooth, consistency, preserves the integrity of the protrusions 5 and limits the deterioration by abrasion of the latter.

The specific design adopted thus makes it possible to avoid any contact of the teeth with a hard point area or a hard surface, which again contributes to the atraumatic and comfortable character of the brush 1.

The use of a soft ring 91 to form the bearing makes it possible to promote a significant angulation of the roller with respect in particular to the cover 8, which is likely to expose the internal face 80. The covering of the internal face 80 with a soft material allows to limit the traumatic risk to the tissues of the mouth by the internal face thus exposed due to the angulation of the roller with respect to the cover 8.

Advantageously, the protective piece 9 includes a front wall 9A which runs in front of said distal end 41 of the roller 4 for brushing teeth, so as to mask the latter to avoid a potentially traumatic contact with the front face of the roller 4 for brushing teeth, corresponding to the distal end 41, with the mucous membranes. The brushing roller 4 is thus interposed between the ring 91 on the one hand and the front wall 9A on the other hand. For example, said front wall 9A includes a plurality of pins which run parallel to a plane substantially perpendicular to said first rotation axis Y-Y′, and therefore also in this case perpendicular to said central longitudinal axis X-X′. Said plurality of pins of the front wall 9A thus forms a soft lining arranged opposite the distal end 41 of the brushing roller 4, in the axial extension of the latter and substantially transversely to the first rotation axis Y-Y′. The soft lining formed by the pins in question forms a cover of the brushing roller 4 at an a priori non-functional area of the latter, making it possible to avoid any interference of the non-functional area in question with the mucous membranes, while having a soft character, and therefore respectful of the tissues and providing a comfortable brushing. Advantageously, the pins forming this soft lining may also be used for the brushing. Said pins run for example over two rows disposed one behind the other as illustrated in the figures, thus forming a tuft of bristles which not only protects the mucous membranes of the free front face of the roller 4 but also makes it possible to ensure a brushing function in addition to that provided by the roller 4 for brushing teeth.

Advantageously, the protective piece 9 is integrally formed by a single piece which includes a central body with a footprint 93 intended to receive the cover 8 in an adjusted manner, said central body being provided with the ring 91 at one of its ends, and the plurality of pins forming the front wall 9A at the other end. The single piece which forms the protective piece 9 may thus be obtained by molding plastic material, and for example by molding a silicone, an elastomer or even a thermoplastic elastomer (TPE), such as polystyrene-b-poly(ethylene-butylene)-b-polystyrene (SEBS) or polystyrene-b-polybutadiene-b-polystyrene (SBS) as mentioned previously. Advantageously, the protective piece 9 is overmolded on the cover 8 and the top of the first casing 30, as illustrated in the figures. This embodiment is preferred because it allows a simple, rapid and economical industrial manufacturing. The implementation of a bearing formed at least in part by the ring 91, which encloses the top of the first casing 30 at an orifice provided through the latter and from which emerges said extremal segment 70, also facilitates the manufacturing, allowing, thanks to its deformability, the insertion of the core 4A into the well opening at the first end 7A of the drive shaft 7.

Advantageously, and as illustrated in the figures, the brushing head 3 embeds said brushing roller 4, first casing 30, cover 8 and protective piece 9. In the preferred embodiment illustrated in the figures, the drive shaft 7 comprises in turn advantageously:
a receiving segment 700 embedded by the brushing head 3 and including said first end 7A
and a motor segment 701 which is embedded by the main body 20 and includes said second end 7B.

The receiving segment 700 is thus advantageously housed within the first casing 30, while the motor segment 701 in turn is advantageously housed within the second casing 20A.

Advantageously, the receiving segment 700 is provided with a first mechanical coupling means 700A while the motor segment 701 is provided with a second mechanical coupling means 700B, intended to cooperate with the first mechanical coupling means 700A, when the brushing head 3 is directly mounted to, and attached to, the main body 20, to establish a mechanical drive connection between the receiving segment 700 and the motor segment 701. More precisely, said first and second mechanical coupling means 700A, 700B are complementary to removably link said motor 701 and receiving 700 segments in rotation. Preferably, at least one of said first and second mechanical coupling means 700A, 700B forms a female coupling member, while the other of said first and second mechanical coupling means 700A, 700B forms a conjugated male coupling member. For example, the first mechanical coupling means 700A is formed by a polygonal-shaped coupling footprint provided at a free end of the receiving segment 700 located opposite the first end 7A, while the second mechanical coupling means 700B comprises a coupling endpiece of conjugated polygonal shape disposed at a free end of the motor segment 701, located opposite the second end 7B. Said coupling endpiece thus forms a multi-sided endpiece intended to be inserted into the aforementioned coupling footprint to communicate to the receiving segment 700 the rotary movement of the motor segment 701 imparted by the motor 6.

Preferably, in accordance with the embodiment illustrated in the figures, the drive shaft 7 includes a first shoulder 10, which is for example positioned so that said extremal segment 70 runs between said first end 7A and said first shoulder 10. Advantageously, the drive shaft 7 also includes a second shoulder 11, which is preferably disposed between the first shoulder 10 and the first mechanical coupling means 701. Advantageously, the receiving segment 700 thus includes said first and second shoulders 10, 11, the latter being able in particular to hold in position the receiving segment 700 within the first casing 30 of the head 3, as will emerge from the description which follows. Advantageously, said first and second shoulders 10, 11 are disposed facing each other, that is to say they define respective support surfaces which face each other, as illustrated in the figures. Said first and second shoulders 10, 11 are further disposed at a distance from each other, so that the drive shaft 7 comprises an intermediate segment 71 which runs between said first and second shoulders 10, 11.

Advantageously, said first casing 30, within which runs the receiving segment 700 which advantageously carries the first and second shoulders 10, 11, includes within it an elongated cavity 30A delimited by a cavity wall 30B. The latter preferably has a shape substantially of revolution along the central longitudinal axis X-X′, and its cross section varies longitudinally (that is to say along the central longitudinal axis X-X′) so as to form first and second axial stops 300, 301 for respectively said first and second shoulders 10, 11. The cavity wall 30B therefore has different portions of different sections, the first and second axial stops 300, 301 being formed by notches at the interface between two adjacent portions of different sections. Thus, the first shoulder 10 is intended to rest on and against the first axial stop 300, while the second shoulder 11 is intended to rest on and against the second axial stop 301, which makes it possible to block the axial position of the drive shaft within the first casing 30. Preferably, each of said first and second shoulders 10, 11 forms a respective stopping surface running in a respective plane which is substantially perpendicular to the central longitudinal axis X-X′. In the same way, the first and second axial stops 300, 301 are advantageously formed by plane annular surfaces which each also run in a respective plane substantially perpendicular to the central longitudinal axis X-X′. This design, which implements two plane/plane stops facing each other, makes it possible to block the shaft 7, and more precisely the receiving segment 700, in a predetermined axial position, within the first casing 30, with a precise control of clearances linked to the positioning of the drive shaft 7 in said first casing 30.

In order not only to facilitate manufacturing but also to obtain precise and robust mechanical mounting, the drive shaft 7 preferably includes first and second distinct elements 72, 73 assembled together and respectively forming said first and second shoulders 10, 11. Preferably, said first and second elements 72, 73 form part of the receiving segment 700 and form the latter when they are assembled together. The first element 72 forms for example the extremal segment 70 and the intermediate segment 71. Preferably, the first and second elements 72, 73 are assembled together by fitting, that is to say by press-fitting a female element in a male element. The second element 73 runs for example longitudinally between a primary end and a secondary end and comprises an assembly sleeve 730 which opens at said primary end. Said assembly sleeve 730 receives an assembly endpiece 720 which is part of said first element 72 and extends for example said intermediate segment 71. Said assembly endpiece 720 is thus press-fitted into the aforementioned sleeve 730 of the second element 73 to ensure a mutual fastening of said first and second elements 72, 73. Advantageously, the second element 73 forms, at its aforementioned secondary end, said first mechanical coupling means 700A, which is for example in the form of a hexagonal footprint opening at said secondary end. Preferably, said fitting is based on the principle of the Morse cone, that is to say that the assembly endpiece 720 located in the axial extension of the intermediate segment 71 has substantially a conical shape with low slope, while the wall of the assembly sleeve 730 disposed at the primary end of the second element 73 also has a conical shape with low slope, said conical endpiece 720 being fitted into the conical cavity of the sleeve 730, which not only makes it possible to secure in a simple and effective manner the first and second elements 72, 73 to each other, but also to ensure an excellent relative centering of the latter.

Advantageously, the intermediate segment 71 runs at a distance from said cavity wall 30B, that is to say that there is a clearance J0 between the cavity wall 30B and the drive shaft 7, on at least part of the length of the latter. Thanks to the presence of this empty space between the intermediate segment 71 and the cavity wall 30B, the drive shaft 7 is allowed in operation to flex and/or to tilt relative to the central longitudinal axis X-X′, which allows, in combination with the soft character of the ring 91 forming the bearing, to give the roller 4 for brushing teeth a particularly atraumatic character and an ability to conform geometrically to the anatomical shapes with which it interferes during brushing.

The design explained in the above thus makes it possible not only to ensure a particularly reliable and precise axial stopping of the drive shaft 7 thanks to the first and second shoulders 10, 11, but also to provide said shaft 7 with the ability to move locally, laterally in relation to the central longitudinal axis X-X′, which provides a great comfort of use and a remarkable brushing efficiency.

Advantageously, the first axial stop 300 is disposed substantially adjacent to said bearing, and therefore to the ring 91, the aforementioned intermediate segment 71 including a first portion 710 which is advantageously adjacent to said first shoulder 10 and has a conical shape with a cross section decreasing from the first shoulder 10 towards the second shoulder 11 between a maximum cross section and a minimum cross section. The presence, in the vicinity of the bearing, of the first conical portion 710, makes it possible to self-center the drive shaft 7, while allowing the deformation and temporary inclination of the latter thanks to the clearance J0 which increases, along the first portion 710, in the direction of the second shoulder 11.

Advantageously, the intermediate segment 71 includes in turn a second portion 711 which is substantially adjacent to said first portion 710 and has for example a substantially cylindrical shape whose cross section is less than or equal to said aforementioned minimum cross section. Preferably, the cross section of the second portion 711 is less than the minimum cross section in question, the second portion 711 being separated from the first portion 710 by a chamfer 712. Thanks to these geometric characteristics, the first element 72 is easy and quick to mount and assemble with the second element 73.

The second element 73 has in turn a shape substantially of revolution with two different sections. Thus, the part of the second element 73 which forms the aforementioned assembly sleeve 730 has a first cross section dimensioned to leave a clearance J1 between the cavity wall 30B and the part of the second element 73 concerned, which limits friction, facilitates mounting and promotes the flexion and/or inclination of the drive shaft 7. The second element 73 also comprises a second part 731 which has a cross section greater than that of the first part mentioned above. This second part 731 incorporates, as mentioned previously, the first mechanical coupling means 700A. The cross section of the second cylindrical part 731 is adjusted to that of the cavity 30A so as to locally maintain the drive shaft 7 coaxial with the central longitudinal axis X-X′.

Thus, in the specific design illustrated in the figures and described in the above, the drive shaft 7 is maintained centered on the central longitudinal axis X-X′ only in two spaced areas, corresponding respectively to the extremal segment 70 and to the second part 731 of the second element 73, said drive shaft 7 being everywhere else disposed at a distance from the cavity wall 30B of the first casing 30. This particular design not only allows a precise control of the clearances linked to the positioning of the shaft 7 in the first casing 30, as mentioned previously, but also allows a deformation in operation of the drive shaft 7 which makes it possible to obtain a particularly effective and atraumatic brushing.

In order to reduce the parasitic vibrations likely to be induced by a potential misalignment of the mechanical components resulting from the manufacturing tolerances of the latter, the drive shaft 7 comprises a first segment 80 and a second segment 81 as well as a universal joint 12 for connecting said first and second segments 80, 81. The first segment 80 preferably includes said second end 7B as well as a means for mechanically coupling to the output shaft 6A, formed for example by the footprint disposed at the second end 7B mentioned previously. The first segment 80 comprises a male part of said universal joint 12, which itself includes a substantially spherical convex part 80A projecting as well as lugs 80B, 80C which run laterally, perpendicular to the central longitudinal axis X-X′. The second segment 81 advantageously includes in turn the motor segment 701 mentioned previously. In this case, said motor segment 701 is provided with a spherical curved concave portion 81A of shape conjugate to that of the spherical convex portion 80A of the first segment 80. Said spherical convex portion 80A and spherical curved concave portion 81A are in mutual sliding contact to form a ball joint. Advantageously, said spherical curved concave portion 81A is extended by a cylindrical cap within which is inserted the top of the first segment 80 which carries said spherical convex portion 80A and said lugs 80B, 80C. Said cylindrical cap advantageously comprises two guide slots which accommodate the lugs 80B, 80C, in order to allow a relative axial sliding of the first and second segments 80, 81, but with a lock in rotation along the first rotation axis Y-Y′. The universal joint 12 thus forms a spherical finger connection, making it possible to compensate for a potential misalignment of the motor segment 701 and the receiving segment 700. Preferably, the guide lungs 80B, 80C which make it possible to transmit the rotary movement imparted by the motor 6, run along a transverse axis which passes through the center of the sphere in which fits the surface of the spherical convex portion 80A. The universal joint 12 conforming to the preceding description thus makes it possible to benefit from a rigid stop ensuring the positioning of the assembly while retaining the possibility of pivoting about the first rotation axis Y-Y′ in a cone whose half-angle at the top is advantageously greater than or equal to 5°. The implementation of the universal joint 12 makes it possible in particular to avoid operating under stress and therefore improves the lifespan of the mechanical components concerned, while providing an increased comfort of use by reducing the possible parasitic vibrations induced by a potential misalignment, as mentioned previously.

Furthermore, the second segment 81 advantageously includes, at its end opposite the universal joint 12, the second mechanical coupling means 700B. As mentioned previously, the second mechanical coupling means 700B advantageously includes a multi-sided endpiece, which is advantageously extended by a cylindrical guide head 7000 which facilitates the centering and insertion of the terminal part of the motor segment 701 into the terminal part of the receiving segment 700.

Advantageously, the toothbrush 1 comprises a lip seal 13 which preferably has a shape of revolution and locally surrounds the motor segment 701, and in this case the second segment 81, on a portion of the latter which is adjacent to an orifice provided in the second casing 20A and from which emerges the second mechanical coupling means 700B. Said seal 13 advantageously has shoulders which face each other to maintain the seal 13 axially in position within the second casing 20A, while ensuring the sealing of the latter, including during rotation of the drive shaft 7, and whatever the rotation speed implemented.

The rotation speed of the brushing roller 4 may advantageously be controlled by means of an appropriate control interface disposed for example on the second casing 20A. The control interface in question comprises for example a button 200 allowing the rotation speed to be increased and a button 201 allowing the rotation speed to be instead reduced. The control interface is of course advantageously connected to the motor 6 through a control device, which includes for example an electronic card, which is preferably embedded within the second casing 20A. Advantageously, the brush 1 may comprise a screen 203 displaying for example the duration of the brushing and/or the level of the rotation speed of the roller 4. Advantageously, the control interface also comprises an on/off button 202 which is associated with the electrical switch allowing the brush 1 to be turned on or off.

Preferably, said cover 8 and protective piece 9 form a unitary sub-assembly which occupies, in the absence of mechanical stress exerted on it, a rest position (illustrated in the figures), in which said unitary sub-assembly 8, 9 runs longitudinally in a direction of extension substantially parallel to said first rotation axis Y-Y′. Thanks to the combination of materials from which it is formed, said unitary sub-assembly has a significant flexibility, which thus makes it possible to limit, or even completely avoid, traumatic contact with the tissues (teeth and gums). Preferably, said unitary sub-assembly thus designed:
to flex elastically relative to said first casing 30, in response to a first flexion stress exerted on it, to reach a first position of maximum elastic flexion in which said free front end 8B deviates from said first rotation axis Y-Y′ so that said direction of extension forms with said first rotation axis Y-Y′ a first angle comprised between 3 and 10°, preferably substantially equal to 5°, and/or
to flex elastically relative to said first casing 30, in response to a second flexion stress exerted on it, which is in the direction opposite said first flexion stress, to reach a second position of maximum elastic flexion in which said free front end 8B is gets closer to said first rotation axis Y-Y′ so that said direction of extension forms with said first rotation axis Y-Y′ a second angle comprised between 1 and 4°, preferably substantially equal to 2°.

Ultimately, the invention presents a design which facilitates the geometric variability of the brushing head 3 as a function of the mechanical stresses to which the latter is subjected in use, while retaining an extremely reliable operation and preserving the lifespan of the mechanical components concerned. The brush 1 according to the invention thus makes it possible to benefit from particularly effective and atraumatic brushing, while being of robust, light and durable design.

### INDUSTRIAL APPLICABILITY

The invention finds its industrial application in the design, manufacture and use of electric toothbrushes.

1. An electric toothbrush (1) comprising an electric motor (6), a roller (4) for brushing teeth, a drive shaft (7) running longitudinally between a first end (7A) secured to said brushing roller (4) and a second end (7B) connected to said electric motor (6) to rotate said brushing roller (4) through said drive shaft (7) along a first rotation axis (Y-Y′), said brushing roller (4) running longitudinally between a proximal end (40) attached to said drive shaft (7) and a free distal end (41), said toothbrush (1) further comprising a first casing (30) within which runs said drive shaft (7), as well as a cover (8), made of a first material, which extends longitudinally said first casing (30) and runs along said brushing roller (4) between a rear end (8A) secured to the first casing (30) and a free front end (8B), said cover (8) having an internal face (80) located facing said brushing roller (4) and an opposite external face (81), said drive shaft (7) comprising an extremal segment (70) emerging outside said first casing (30) and which includes said first end (7A), said toothbrush (1) comprising a bearing which is secured to said first casing (30) and receives said extremal segment (70) to guide it, said electric toothbrush (1) being characterized in that it comprises a protective piece (9) made in a second material softer than said first material, said protective piece (9) cladding said internal face (80) and projecting from the latter to form a peripheral lip (90) surrounding said cover (8), said protective piece (9) including a ring (91) locally surrounding said extremal segment (70) to form said bearing.

2. The electric toothbrush (1) according to claim 1 characterized in that said protective piece (9) includes a front wall (9A) which runs in front of said distal end (41), so that said brushing roller (4) is interposed between said ring (91) on the one hand and said front wall (9A) on the other hand.

3. The electric toothbrush (1) according to claim 2 characterized in that said front wall (9A) includes a plurality of pins which run parallel to a plane substantially perpendicular to said first rotation axis (Y-Y′).

4. The electric toothbrush (1) according to claim 1, characterized in that said cover (8) is integral with said first casing (30).

5. The electric toothbrush (1) according to claim 1 characterized in that said drive shaft (7) includes first and second shoulders (10, 11) disposed facing and at a distance from each other, said first casing (30) including within it an elongated cavity (30A) delimited by a cavity wall (30B) whose cross section varies longitudinally so as to form first and second axial stops (300, 301) for respectively said first and second shoulders (10, 11).

6. The electric toothbrush (1) according to claim 5 characterized in that said drive shaft (7) comprises an intermediate segment (71) which runs between said first and second shoulders (10, 11), at a distance from said cavity wall (30B).

7. The electric toothbrush (1) according to claim 6 characterized in that said first axial stop (300) is disposed substantially adjacent to said bearing, said intermediate segment (71) including a first portion (710) which is adjacent to said first shoulder (10) and has a conical shape with a cross section decreasing from the first shoulder (10) towards the second shoulder (11) between a maximum cross section and a minimum cross section.

8. The electric toothbrush (1) according to claim 7 characterized in that said intermediate segment (71) includes a second portion (711) which is substantially adjacent to said first portion (710) and has a substantially cylindrical shape whose cross section is less than or equal to said minimum cross section.

9. The electric toothbrush (1) according to claim 5 characterized in that said drive shaft (7) includes first and second distinct elements (72, 73) assembled together, for example by fitting, and respectively forming said first and second shoulders (10, 11).

10. The electric toothbrush (1) according to claim 1 characterized in that it comprises on the one hand a main body (20) and on the other hand a brushing head (3) removably mounted on said main body (20), said main body comprising a second casing (20A) which forms a manual gripping member (2) and within which is housed said electric motor (6) while said brushing head (3) embodies said brushing roller (4), first casing (30), cover (8) and protective piece (9), said drive shaft (7) comprising:
a receiving segment (700) embedded by said brushing head (3) and including said first end (7A), said receiving segment (700) being provided with a first mechanical coupling means (700A),
a motor segment (701) embedded by said main body (20) and including said second end (7B), said motor segment (701) being provided with a second mechanical coupling means (700B),
said first and second mechanical coupling means (700A, 700B) being complementary to removably link said motor (701) and receiving (700) segments in rotation.

11. The electric toothbrush (1) according to claim 5 characterized in that said receiving segment (700) includes said first and second shoulders (10, 11).

12. The electric toothbrush (1) according to claim 1 characterized in that said drive shaft (7) comprises a first segment (80) and a second segment (81) as well as a universal joint (12) to connect said first and second segments (80, 81).

13. The electric toothbrush (1) according to claim 1, characterized in that said cover (8) and protective piece (9) form a unitary sub-assembly which, in the absence of mechanical stress exerted on it, occupies a rest position in which said unitary sub-assembly runs longitudinally in a direction of extension substantially parallel to said first rotation axis (Y-Y′), said unitary sub-assembly being designed:
to flex elastically relative to said first casing (30), in response to a first flexion stress exerted on it, to reach a first position of maximum elastic flexion in which said free front end (8B) deviates from said first rotation axis (Y-Y′) so that said direction of extension forms with said first rotation axis (Y-Y′) a first angle comprised between 3 and 10°, preferably substantially equal to 5°, and/or
to flex elastically relative to said first casing (30), in response to a second flexion stress exerted on it, which is in the direction opposite said first flexion stress, to reach a second position of maximum elastic flexion in which said free front end (8B) is gets closer to said first rotation axis (Y-Y′) so that said direction of extension forms with said first rotation axis (Y-Y′) a second angle comprised between 1 and 4° preferably substantially equal to 2°.
